(19) United States
(12) Patent Application Publication
(10) Pub. No.: US 2024/0354678 A1
(43) Pub. Date: Oct. 24, 2024

(54) Method for Logging a Scientific Experimental Workflow

(71) Applicant: Chemspeed Technologies AG, Füllinsdorf (CH)

(72) Inventors: Rolf Gueller, Herznach (CH); Mathias Cherbuin, Liestal (CH)

(21) Appl. No.: 18/685,545

(22) PCT Filed: Aug. 23, 2022
(86) PCT No.: PCT/CH2022/050021

§ 371 Date: Feb. 22, 2024

(30) Foreign Application Priority Data
Aug. 25, 2021 (CH) CH070202/2021

(51) Int. Cl. G06Q 10/0633

(52) U.S. Cl. CPC G06Q 10/0633

(57) ABSTRACT

In a method for logging and analysing a scientific experimental workflow, over the course of the workflow a video recording, which includes a multiplicity of successive individual images, of at least parts of a workspace in which the workflow is being executed and, at the same time, values of parameters relevant to the workflow are recorded and stored as separate data sets in a digital data bank. The data sets contain the individual images of the video recording and the values of the parameters over time assigned to a common reference time, so that at each timepoint there is a clear temporal association between the individual images of the video recording and the values of the parameters. The data sets of the parameters are stored in a searchable form, so that it is possible to search for parameter events at which a parameter exhibits a searched value or a searched change. The values of at least selected parameters and the images of the video recording are preferably visually displayed in temporal association with one another.

### CROSS REFERENCE TO RELATED APPLICATIONS

This application is the United States national phase of International Patent Application No. PCT/CH2022/050021 filed Aug. 23, 2022, and claims priority to Swiss Patent Application No. CH070202/2021 filed Aug. 25, 2021, the disclosures of which are hereby incorporated by reference in their entireties.

### BACKGROUND OF THE INVENTION

### Field of the Invention

The recording of chemical or other scientific experiments and workflows is usually effected in the form of a log of tasks, measurements and observations recorded manually by the user. Thus, a user (for example a laboratory worker) logs, for example, each individual working step of a workflow as a succession of working steps and tasks that have taken place sequentially in chronological succession, as well as measurements and observations.

### Description of Related Art

In automated work devices for performing scientific experiments and/or manufacturing processes, as well individually as sequentially or in parallel, usually a large number of parameters are also recorded. For example, the measured values of sensors, as well as tasks performed by the devices, are recorded automatically and in this case too the recording is effected sequentially (in the case of parallel workflows also in parallel). If a corresponding work device has a plurality of sensors, measuring devices or parameters measurable in some other way, the respective individual measurements/recordings are likewise recorded sequentially. Here the term “parameter” in each case denotes a value determined experimentally or by a method or a device, a planned value, a planned or executed action, a recording in any form, but also a value observed, for example, by a laboratory worker or a subjective observation/interpretation of the observer.

In such cases the recording thus created therefore consists of a sequential succession of individual measurements, recordings and observations, and the evaluation of the totality of that data and information often requires time-consuming and laborious manual or visual filtering and searching of the desired information. In particular, the (temporal) linking of that data and information to the workflow log and a clear presentation of such linking have remained unsolved by technology hitherto.

In a laboratory, every time a scientific experiment or a scientific experimental workflow is performed an enormous amount of data of extremely varied forms and kinds is generated, and since new workflows are constantly being executed, the volume of that data increases accordingly. Searching through that totality of data for individual desired parameters, values or information has traditionally presented a huge challenge for the laboratory worker and, even in the case of information available in the form of a video recording, linking that data to visual inputs in the log is virtually impossible. For example, in the case of video recordings of a workflow it is necessary to look through an entire recording in order to identify and interpret a desired event (for example a colour change, superheating, foaming . . . ) and, for example, to link that event to a different data series, for example of a thermometer, in order to interpret that relationship.

If an experiment is recorded visually using a camera there is the great disadvantage that even using the best AI systems (artificial intelligence) it is possible to carry out only an extremely limited search for specific data, as well as the difficulty of temporally connecting specific image sequences to corresponding data recorded using other recording techniques, sensors, etc.

### SUMMARY OF THE INVENTION

The object of the invention is to simplify and optimise the recording and logging of all relevant data involved in a workflow, especially of all data with video recordings, IR, UV or other recording techniques or other complex recording methods (sound, ultrasound, radioactivity . . . ) so that it is possible to perform a simple search for parameters and events across entire workflows, some of which are of very long duration, or even across a multiplicity of different workflows.

Specifically the aim of the invention is to simplify the recording and logging of the totality of all relevant measurable and observable parameters of the operations and devices involved in a scientific experimental workflow, as well as actions and observations of a user, so that a later analysis of the totality of information can be carried out in as simple, quick and targeted a way as possible, and in such a way that all those data can be connected to a video recording of the workflow directly and at any timepoint.

The problem underlying the invention is solved by the methods according to the invention as defined herein.

The core of the method according to the invention for logging a scientific experimental workflow lies in the following:

In a method for logging a scientific experimental workflow, over the course of the workflow a video recording, which comprises a multiplicity of successive individual images, of at least parts of a workspace in which the workflow is being executed and, at the same time, values of parameters relevant to the workflow are recorded and stored as separate data sets in a digital data bank. The data sets contain the individual images of the video recording and the values of the parameters over time assigned to a common reference time, so that at each timepoint there is a clear temporal association between the individual images of the video recording and the values of the parameters. The data sets of the parameters are stored in a searchable form, so that it is possible to search for parameter events at which a parameter exhibits a searched value or a searched change.

The core of the method according to the invention for logging and analysing a scientific experimental workflow lies in the following:

In a method for logging and analysing a scientific experimental workflow, over the course of the workflow a video recording, which comprises a multiplicity of successive individual images, of at least parts of a workspace in which the workflow is being executed and, at the same time, values of parameters relevant to the workflow are recorded and stored as separate data sets in a digital data bank. The data sets contain the individual images of the video recording and the values of the parameters over time assigned to a common reference time, so that at each timepoint there is a clear temporal association between the individual images of the video recording and the values of the parameters. The data sets of the parameters are stored in a searchable form, so that it is possible to search for parameter events at which a parameter exhibits a searched value or a searched change. The values of at least selected parameters present at the timepoint of a searched parameter event or present in a time period that includes the timepoint of the searched parameter event and the images of the video recording are visually displayed in temporal association with one another.

Using the methods according to the invention, recorded videos can be searched with reference to synchronously recorded parameter values in a simple, quick and targeted manner, and vice versa.

In the methods according to the invention, the recording or storage of all values of the parameters in separate data sets is effected synchronised in the same way as a soundtrack of a film, only in the case of scientific experimental workflows often hundreds of such data sets are recorded. In each of those data sets, a search can be made in accordance with specific criteria and immediately linked to the video recording, that is to say the corresponding video sequence is automatically and conclusively assigned. In this way a video recording, possibly also in different wavelength ranges, of a scientific experimental workflow can be efficiently searched and it is possible to visually view or trace what happened visually at the point in time at which a specific parameter value or a specific change in that value occurred in the workflow and/or what was being manipulated at exactly that timepoint or beforehand.

It is here important to the invention that for each individual measurable or observable parameter there is created a dedicated data set and/or a derivative thereof (for example a temperature gradient as a derivative of a temperature) in which all values or changes in value of the parameter are recorded. Thus, a data set of a temperature sensor would record, for example, each measured temperature or change in temperature as well as the timepoint of the temperature measurement or the change in temperature, or the data set of an automated metering device would record at which point in time which action (metering of a desired substance into a desired target object) was carried out and what result was obtained (here, for example, what amount was actually metered). A combination of the data sets shows how the workflow has performed and, together with a visual display, provides searchable visual logging.

It will be understood that the temporally precisely associated data series can also be converted, for example, into other values, or statistically smoothed. Outliers (for example measured values that occur for only less than 0.1 second) can be deleted. Or a new, time-alibrated data series can be created which calculates the difference of two data sets or, for example, an increase in speed. It is also possible to search in those converted data series, so that the corresponding video recording(s) can then be assigned and displayed.

In the method according to the invention, those individual parameters or data sets are displayed in a way similar to that known, for example, from the music or film industry, with each parameter being displayed as a “track”. All data sets are recorded synchronously, that is to say in temporal association, and selected data sets or all data sets are visually displayed, for example on a screen.

What is crucial according to the invention is that all recorded data sets are time-synchronised, this being essential in order that the timepoints of individual measured values, observations, recordings and actions can later be found in relation to the totality of all measured data and, above all, visually tracked. This first allows “visual logging”, because it is possible simply to search for a property, for example the value of a parameter or the change in the value of the parameter. The time-referencing can be effected in relation to a desired timepoint (for example the starting point of the workflow), each measurement/log then relating to that timepoint.

Advantageously, the recording timepoints refer to a universal timescale, such as, for example, universal time (UTC) or international atomic time (TAI), each timepoint of a measurement referring to that corresponding universal time axis, and later each individual data point can be unambiguously precisely temporally associated.

Advantageously, for selected parameters, target values of those parameters are stored as data sets in the data bank and visually displayed together with the recorded actual values of those parameters. Advantageously, the variations in the values of at least selected parameters over time are visually displayed, if applicable together with their corresponding target values, in tracks arranged one next to the other or one below the other, the variations in the values of at least selected parameters over time, preferably together with associated target values, advantageously being visually displayed in the form of rows of numbers or graphs. This kind of display facilitates the overview over the recorded values of the parameters.

Advantageously, the individual data sets are displayed graphically as parallel tracks integrated in the visual recording or in the parallel visual recordings (video(s)) of a workflow in such a way that they show a table running synchronously with the visual display (video) above the videos or next to the video recording, which run along a common time axis.

It will be understood that it is also possible to arrange the display of the tracks horizontally one next to the other (the tracks themselves running vertically, with the time axis running in the vertical direction, for example from top to bottom), or vertically one above the other (the tracks themselves running horizontally, with the time axis running in the horizontal direction, for example from left to right). A display across a plurality of screens or different output devices (for example a combination of a screen and an augmented reality display device (Microsoft's HoloLens)) is also a possibility.

Advantageously, two or more video recordings of the workspace are made from different viewing angles and/or in different wavelength ranges and stored as separate data sets. Advantageously, radiation values such as, for example, radioactivity or X-ray radiation, magnetic field values, airflow values or ultrasound measured values are also stored as separate data sets and can also be shown overlaid one above the other for the purpose of more effective or more intuitive playback, searching or display.

Video recordings from different viewing angles show more details of the workflow and can also be displayed overlaid or partly overlaid or, for example, combined to form a three-dimensional display and, for example, displayed additionally with the aid of augmented reality devices.

Video recordings in different wavelength ranges (for example visible light, UV or IR) as well as other radiation values, magnetic field values, airflow values or ultrasound measured values likewise provide additional information about the scientific experimental workflow.

Advantageously, the values of at least selected parameters, together with the respective timepoint, are input into the data bank automatically or manually by a user.

The user can advantageously mark (tag) a desired image or a video sequence, as well as a value or an event of a data track, in order to make it easier to find later in the totality of recordings and parameters. Such marking can in certain cases also be carried out by automation, in which desired parameters are identified from a complex data track, such as, for example, a video or audio recording, by means of image-recognition or sound-recognition methods and the timepoints or sequences are marked accordingly (for example for certain colours, changes in colour, sounds, and any other wavelengths, or values, patterns and properties detectable by automation). For example, in an IR video recording it would be possible to mark sequences in which a certain maximum temperature is detected. It is, of course, also possible to mark a plurality of data sets or tracks, this then especially again providing the ability to make a link between data tracks and the events recorded therein.

Advantageously, observations recorded in text form or, preferably parameterised, acoustic recordings by a user are stored as separate data sets. It is thus also possible for verbalised thoughts, observations and interpretations of the event observed by the user to be parameterised and assigned to a data track.

Accordingly, it is also possible for parameters other than those coming from technical devices to be recorded and stored. These could be, for example, the manual tasks and/or observations of the laboratory worker who is working with a manual, semi-automated or automated device. For example, at a timepoint during the automated workflow it would be possible to carry out a manual addition of a substance, which an automated laboratory device is unable to perform. The experiment could be recorded (filmed) in the synchronised manner described above at, for example, three different wavelengths (for example UV, visible, IR) using HoloLens-like glasses. Or, for example, the user logs an observation about the device which he makes while the workflow is proceeding automatically, together with the timepoint of the observation. The observations or, for example, sound inputs made by the user are likewise recorded in a data set or a plurality of separate data sets, it always been crucial that everything is synchronised with the video recording made of the experiment over a specific wavelength (or a plurality of video recordings from different viewing angles or wavelengths), whether this relates to automated recordings (for example by means of sensors) or to manual inputs, and that each kind of such recordings is recorded in a separate data set (which, of course, can technically also be overlaid data sets which are, however, searchable individually). Planning data (of the scientific experimental workflow), that is to say both the planning protocol and (target) data etc. expected at a certain timepoint, are also stored in searchable form as dedicated data sets in precisely the same format, synchronised with the video recordings. It is accordingly possible to display the video sequences belonging to a searched (and found) planning datum (for example a target temperature) and values of the other parameters.

In order further to simplify the display or to play back more intuitive information or to play back summary information, appropriate data sets are advantageously grouped and combined or also scaled or converted, and thus aggregated data are run synchronously (for example pressure is calculated from temperature and other to some extent constant data and played back). A temperature-control device, such as, for example, a cryostat, comprises a large number of individual items of information which could each have a dedicated data set, such as target value of the temperature control at a timepoint, temperature actually measured, as well as flow rates of a temperature-control medium, system information (warning/error messages), control parameters, or simply just whether a certain element of the device (heating element or pump for the temperature-control medium) is on or off, etc. The recording of all those individual parameters can likewise be stored in a data set (for example T0: starting of the pump, T0+1 s: measurement of the temperature: 25.3° C., T0+2 s: starting of the heating element, T0+9 s: measurement of the temperature; 25.5° C., . . . ), or each individual sub-parameter (here, for example, a) activity of the pump, b) activity of the heating element and c) measured value of the temperature sensor) is recorded as an individual data set, it being possible, however, for the data sets to be combined and displayed later, either combined in a track or “opened up” in a plurality of tracks. It will be understood that the user can select in a display just the data sets which are useful to him for the desired analysis. The user can therefore configure the display flexibly in accordance with his current needs and, for example, have the video image displayed on one side of the screen and his desired data tracks of desired parameters on the other side, the focus in those data tracks in each case being on the timepoint which is also shown in the video image. The visualisation of the additionally displayed data tracks advantageously also shows a desired region before or after the timepoint currently displayed in the video image, this enabling the user to be shown at a glance the parameter values both before and after the current timepoint. The user is thus given valuable insights into what happened before an event (and what may have led to that event) and what happened after the event (and what may have been caused or at least affected by that event).

Furthermore, certain parameters are advantageously played back in visual form, whether in the form of warning signals in the case of certain parameter values being exceeded or simply just to display the temperature, instead of in numbers, in a colour gradient running, for example, from blue to red according to the temperature. It will be understood that the data can come not only from sensors or from the visual or acoustic recordings, but an experimenter can also input a visual observation (for example haptics, foaming, or some other parameter not capturable by available sensors or cameras). Those inputs are also captured, with the exact time thereof, and stored synchronously (for example a written input, in the form of a sound recording or by addition of symbols, such as ticks, exclamation marks, Smilies, asterisks and the like).

Advantageously, planning data of the scientific experimental workflow are captured synchronously with the visual recording or the visual recordings in the same way and stored in dedicated data sets. Those planning data are preferably displayed in local association with the corresponding displays of the real data recorded during the workflow. It is in this way possible to enter a search command, for example «Show the visual recordings 20 seconds before reaching a point and 30 seconds after that point, at which the real value of a recorded parameter (for example temperature) corresponds to the planning value for longer than 5 seconds» or «Show the video recording beginning 10 seconds before the planned addition of substance X and ending 20 seconds after the effective addition of substance X (or vice versa, if applicable)».

In the data sets of the data bank it is possible to search not only for values or changes in value of the parameters (not originating from video recordings). Advantageously, known methods of image recognition are used to search the video recording or video recordings for specific image contents or changes in the image contents. The values of at least selected parameters temporally associated with the occurrence of the searched image contents or changes therein or with a selectable time period around the occurrence of the searched image contents or changes therein and the images of the video recording are then visually displayed in temporal association with one another. In this way it is also possible to search in the reverse direction, for example «Search for the point at which the colour (of the contents of a reactor) changed from yellow to blue and display the change in the parameters pressure and temperature 2 minutes before that change and 5 minutes afterwards and run the video recording(s) in parallel therewith».

An important advantage of the method according to the invention is that the totality of recorded data and information is easily searchable, analysable, and displayable in context, for example by selection of a desired timepoint or a desired time period, and then all information of all recording tracks temporally associated with that timepoint or that time period are displayed (of course filtered as required), or a search is made for specific parameters (for example all additions, all additions of a specific substance, all additions to a specific target vessel, all error messages, all temperature measurements having a temperature higher than a specific value, . . . ). Advantageously, this can be used not only in the case of an individual scientific experimental workflow, but also across a plurality of comparable scientific experimental workflows executed in parallel or sequentially, and those workflows can be displayed on one or more screens or output devices. What is crucial here is primarily that visual recordings of workflows can in this way be searched with reference to measurement data and the corresponding visual recordings of the workflows can thus be used as efficient logs of even the most complex workflows, which can be searched efficiently for specific features and enable conclusions to be drawn about the visual logging at any time. Visual recordings of workflows alone, without such additional data sets of further parameters, are of only extremely limited value, especially since many workflows can last several hours or days.

In an advantageous configuration of the invention, the totality of the data and information previously recorded during a workflow is evaluated and interpreted by means of software designed for that purpose in order to combine parts of the total information relevant to further applications and make them available for further use. In a further advantageous configuration, this can even include the partly or fully automated creation of working instructions for future processing operations based on the workflow already executed.

In a further advantageous configuration of the invention, for two or more comparable scientific experimental workflows, over the course of each workflow at least one video recording of at least parts of a workspace in which the respective workflow is being executed and, at the same time, values of parameters relevant to the respective workflow are recorded and stored in searchable form as separate data sets in a digital data bank and preferably visually displayed together in temporal association with one another.

For example, it is also possible for different scientific experimental workflows (for example experiments performed in parallel) to be synchronised with one another and displayed (for example «Show all experiments in which the yellow colour was retained for at least 10 seconds and the associated timepoint, and run the corresponding video recordings before or after that timepoint»).

As common reference timepoint between recordings of a plurality of scientific experimental workflows there can advantageously be used not only a common relative timepoint (in the case of experiments started at different times, for example, the starting time), but also the timepoint of a desired event, for example the reaching or occurrence of a certain event or the performance of a certain action. For example, in the case of a plurality of similar workflows executed one after the other, the common timepoint could be calibrated, for example, to the respective timepoint of the recordings at which, for example, an addition to a vessel was completed, or a temperature was reached, etc. This can also be advantageous if, for example, an experiment has a plurality of reaction vessels which, due to technical constraints, have to be filled one after the other, but the reactions in the vessels need to be compared with one another. In that case the data tracks of the various sub-experiments would be «shifted» so that, on being run, they run in parallel in relation to a reaction-relevant action (here the addition of a substance, which, for example, initiates the beginning of a reaction). Of course, it should advantageously be possible to switch between different methods of time display, parallelisation and standardisation to a common desired relative or absolute timescale.

Advantageously, a scientific experimental workflow logged in that way can also be played on a display device suitable for that purpose (for example an augmented reality device, such as Microsoft's HoloLens) while the laboratory worker is repeating the same workflow or a modified version of that workflow (for example with to some extent customised parameters, working steps, etc.) in order, for example, to develop a new method for a workflow. This can, of course, also take place iteratively over a plurality of cycles.

### BRIEF DESCRIPTION OF THE DRAWINGS

The invention is described in greater detail below with reference to embodiments shown in the drawings, wherein:

FIG. 1—is a diagrammatic view of an exemplary apparatus arrangement for executing a workflow, in the example here a chemical workflow;

FIG. 2—is a simplified principle diagram of a device suitable for carrying out the method according to the invention;

FIG. 3—is a block diagram of the basic steps of an embodiment of the logging and analysis method according to the invention;

FIG. 4—is a block diagram of detailed steps of an embodiment of the logging and analysis method according to the invention;

FIGS. 5-7—show examples of screen displays of the logging and analysis method according to the invention;

FIGS. 8-9—show examples of details from screen displays of the logging and analysis method according to the invention;

FIG. 10—is a simplified representation of data sets displayed in parallel in the form of tracks;

FIGS. 11-12—show an example of a grouped track;

FIG. 13—shows an example of a screen display with superimposed workflow steps;

FIGS. 14-15—show an example for illustrating a search of recorded parameters in accordance with different criteria;

FIG. 16—shows an example for illustrating a search of parameters recorded from three different scientific experimental workflows; and

FIG. 17—shows an example of a display of recordings originating from a plurality of scientific experimental workflows.

### DESCRIPTION OF THE INVENTION

The following definitions are used in the context of the present invention:

A scientific experimental workflow is understood as being any kind of experiment, especially of a chemical, biological or physical nature, for the purposes of research and development. The term workflow or experiment is used therefor hereinbelow.

Parameters are understood as being all kinds of measurement and input variables as well as planning data and specified (target) values which are of relevance or interest to the scientific experimental workflow. These primarily include planned and actually measured measurement variables, such as, for example, temperatures, stirrer speeds, metered amounts, etc., but also, for example, observation-based inputs by the user, for example in text form or in the form of speech inputs.

Data sets are to be understood as being the image data created by the individual video cameras during the scientific experimental workflow as well as the values of the individual parameters, that is to say, for example, measured values or user inputs, the image data and the values of the parameters being assigned to a common reference time. Data sets can also contain planning data, such as, for example, target values or workflow steps.

Tracks are understood as being displays of data sets or excerpts thereof, for example on a screen. They can be, for example, in image form (video recordings, graphic representation of measured values, . . . ), but can also comprise specific values (specific measured values at a timepoint, text, symbols, . . . ) or can be of an acoustic nature (sound recording, . . . ). In particular, tracks are to be understood as line-form or column-form representations of variations in the values of parameters over time.

Parameter events are understood as being situations in which a parameter has a specific state or value or in which its state or value changes in a specific way.

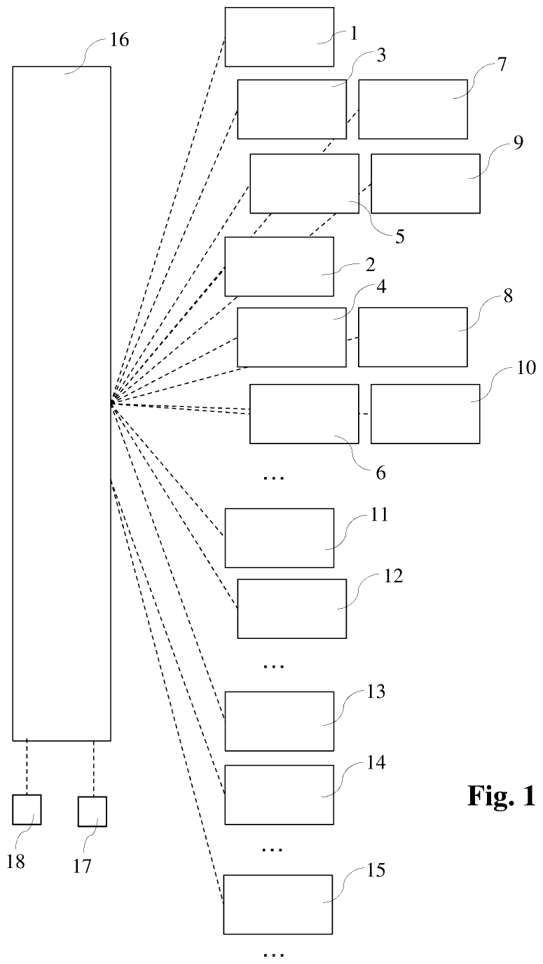

According to FIG. 1, an exemplary workspace comprises two reactors 1 and 2, two heaters 3 and 4 for the two reactors 1, 2, two temperature sensors 5 and 6 for the two reactors 1, 2, two stirrers 7 and 8 for the two reactors 1, 2, two sensors 9 and 10 for the stirring speed of the two stirrers 7, 8, a metering device 11 for the addition of chemicals to the reactors 1, 2, a weighing scales 12 for registering the amounts effectively added, and three video cameras 13, 14 and 15. All said components are connected to a computer 16 and are controlled thereby or deliver the data they have captured to that computer 16. Also connected to the computer 16 are an input device 17 for manual inputs by the user as well as a microphone 18 for acoustic recordings, for example speech inputs by the user. The input device 17 can be, for example, a customarily present keyboard or mouse of the computer 16, but it can also be an input device, for example, in the form of a touch-sensitive screen (touchscreen) or having a visual or acoustic recording function, for example an augmented reality device such as Microsoft's HoloLens (for example by means of gesture and/or speech control).

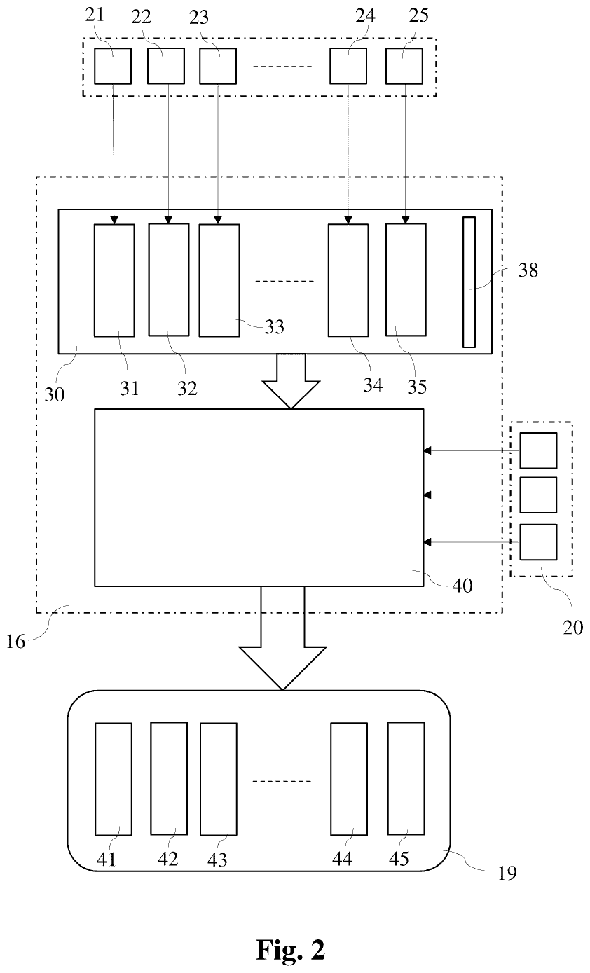

FIG. 2 shows the basic structure of a device suitable for performing an embodiment of the method according to the invention, wherein only the components relevant to the method according to the invention are shown. The device comprises essentially the computer 16 already mentioned and a screen (monitor) 19 connected thereto. Data sources are connected to the computer 16 on the input side, which data sources include, for example, the video cameras 13, 14, 15 already mentioned, the sensors 5, 6, 9 and 10, the weighing scales 12, as well as the input device 17 and the microphone 18. Depending upon the nature of the scientific experimental workflow, it is also possible for further data sources, for example further sensors or other measuring devices, to be provided. In FIG. 2 all those data sources are represented only symbolically by five blocks 21-25. The device further comprises an input field 20 for operating and controlling the functions of the device or the method. That input field can also be realised by software, for example in the form of a menu structure dynamically superimposed on the screen 19 according to the situation.

The computer 16 comprises, as its most important components, a digital data bank 30 and a program, symbolised by a function block 40, which reads out, searches, calibrates, scales and filters data stored in the data bank 30 and visually displays that data in desired form on the screen 19.

The data delivered by the individual data sources during the workflow (video data, measurement data, acoustic data, manual inputs, etc.), that is to say the video recordings and the values of the parameters relevant to the workflow, are stored in the data bank 30 in the form of separate, possibly hierarchically organised data sets, in each case in temporal association with a common reference time which either starts with the beginning of the workflow or is a standard time such as, for example, universal time UTC or international atomic time TAI. The data sets, which are symbolised just by five blocks 31-35 in FIG. 2, accordingly represent the synchronised variations in the data delivered by the data sources over time. The reference time common to all data sets is symbolised in FIG. 2 by the block 38.

The visual display of the workflow is effected on the screen 19. The data sets, which may have been processed and parameterised, and preferably also the individual working steps of the workflow, symbolised in the form of five separate tracks 41, 42, 43, 44 and 45 in FIG. 2, are displayed on the screen.

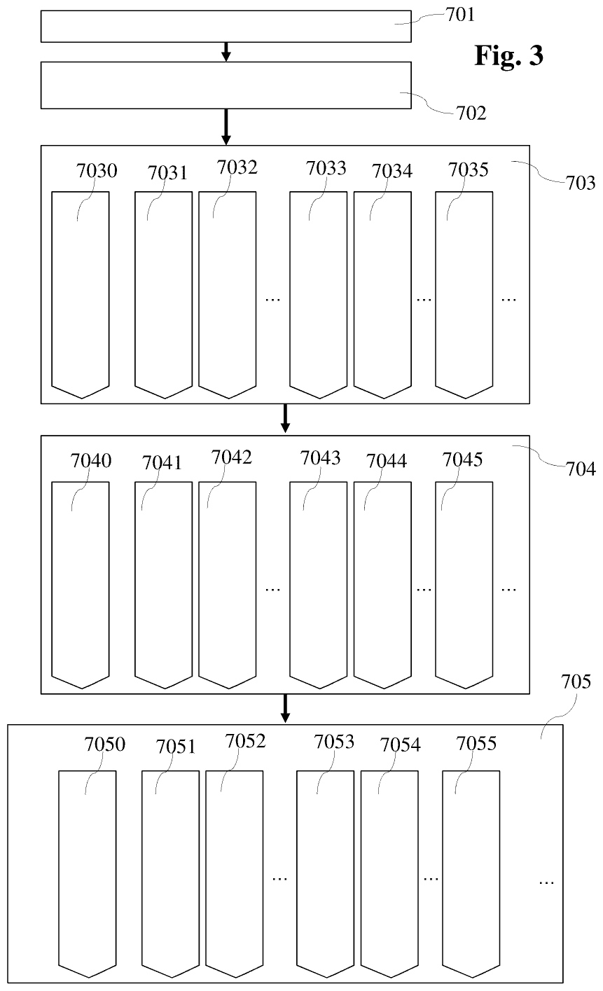

FIG. 3 shows an embodiment of the method according to the invention in the form of a block diagram.

In two introductory steps 701 and 702, the workflow is planned and prepared. This includes the provision of the workspace, of the necessary work devices (reactors, metering devices, stirrers, sensors, etc.) and of the necessary materials as well as of the video cameras and any other input and recording devices.

In the next step 703, the workflow, which in the example here is a chemical workflow, is executed, the image data of the video cameras and the values of all parameters relevant to the workflow being recorded synchronously and stored in the data bank in the form of separate data sets. As already mentioned, the synchronisation is effected with reference to the common reference time. The image data and the values of the parameters bear as it were a time stamp which can be generated automatically in the computer. 7030 symbolises the workflow, the blocks 7031, 7032, 7033, 7034 and 7035 symbolise the recorded raw data of the video camera(s) and the parameters, including the user observations.

The values of the parameters are recorded in a searchable form. That is to say, it is possible to search in the data sets for certain states, values or events.

In the case of simple measured values this is trivial. However, image recordings or acoustic recordings need analysis and processing. This is shown symbolically in step 704. For the image data of the video cameras, image-analysis methods can be used which can autonomously recognise desired image situations (for example a change in the colour of a recorded object). For acoustic recordings, for example speech inputs by a user, it is possible to use speech-recognition methods. Finally, for text inputs, text-recognition methods can be employed. 7040 symbolises the workflow, the blocks 7041, 7042, 7043, 7044 and 7045 symbolise the processed or prepared or parameterised data of the video camera(s) and of the parameters, including the user observations.

In the following step 705, the workflow is visually displayed on the screen 19, the data sets, which may have been processed and parameterised, and preferably also the individual working steps of the workflow being displayed on the screen in the form of separate tracks 7050, 7051, 7052, 7053, 7054 and 7055.

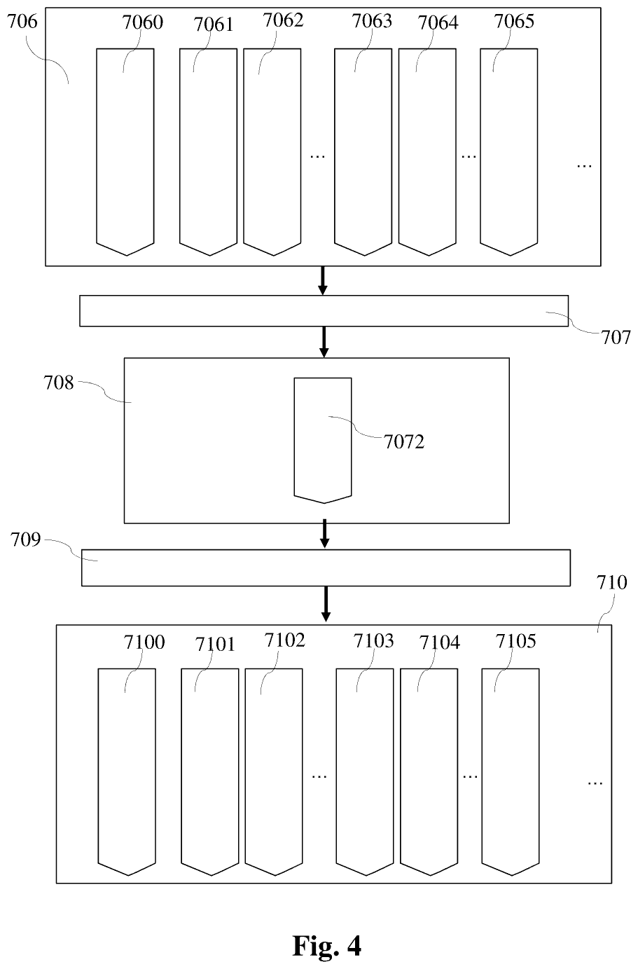

The block diagram of FIG. 4 shows how the visual display of the workflow can be refined in a targeted manner, for example by displaying only specific data sets and/or only specific excerpts thereof, for example in dependence upon a parameter event.

In step 706, as in step 705 of FIG. 3, all data sets, which may have been processed and parameterised, are visually displayed. In FIG. 4 this is symbolised by the blocks 7060, 7061, 7062, 7063, 7064 and 7065. In step 707, a parameter of interest is selected and displayed as track 7072 in step 708. The selection of the parameter of interest can be effected by means of the input field 20 (FIG. 2).

In step 709, a desired parameter event for the selected parameter is input and the event timepoint at which the searched parameter event took place is determined. Such a parameter event can be a specific state (value) of the parameter in question or a specific change in the state or value of the parameter. A parameter event can, however, also be a text or speech input by a user. The selection or input of the parameter event of interest can again be effected by means of the input field 20 (FIG. 2).

Finally, in step 710, time segments of the data sets are visually displayed, those segments focussing on the previously determined event timepoint. That is to say, in the simplest case only the video images and values of the parameters that are assigned to the event timepoint are displayed. Alternatively and preferably, however, the video images and variations in the values of the parameters over a desired time window or time period are displayed, such a time period usually including the event timepoint, for example the last 30 seconds leading up to the event timepoint. It is advantageously possible to set or select whether, during playback, the current timepoint is always to be shown centred in the display and the different tracks flow pass that currently displayed timepoint, or whether the tracks are fixed and the current timepoint moves along the tracks and the time axis. The selection or input of the time period of interest can again be effected by means of the input field 20 (FIG. 2). The displayed tracks are symbolised by blocks 7100, 7101, 7102, 7103, 7104 and 7105 in FIG. 4.

In step 710 it is also possible for only selected data sets or parameters to be displayed. The selection of the parameters or video recordings to be displayed can also be effected by means of the input field 20 (FIG. 2). The input field 20 can, as already mentioned, advantageously be implemented in the form of a software menu displayable on the screen 19.

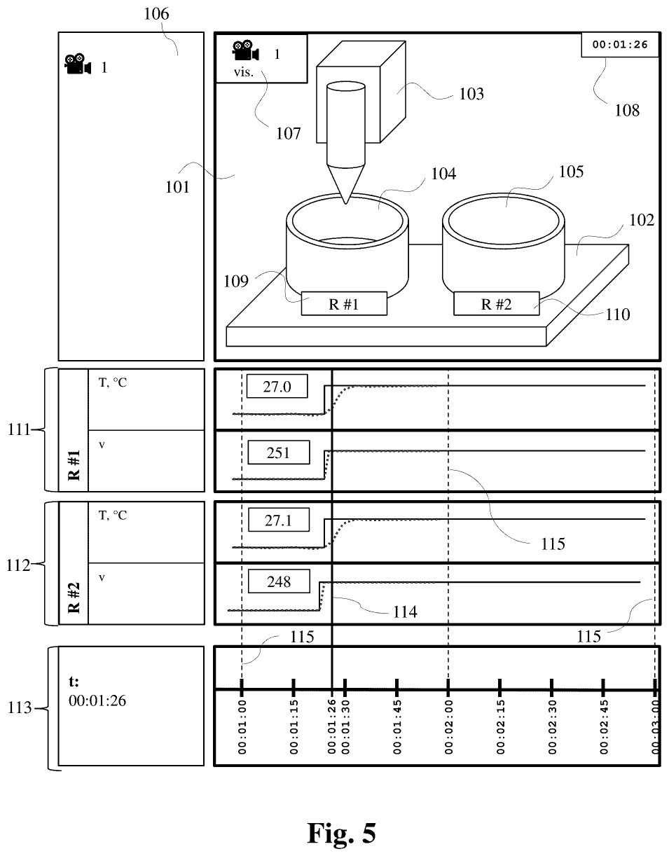

FIG. 5 shows, in extremely simplified form, an exemplary screen layout of an embodiment of the method according to the invention. The screen shows an ongoing video image 101, which in this example is in the process of recording how on an automated formulation device 102 a fluid is being metered into a first reactor 104 by means of a metering device 103. A second reactor 105 is also visible in the video image 101. An information column 106 displays information relating to the camera used for recording the video image 101. Above the video image 101, relevant information is displayed in the form of overlaid graphics, for example the name 107 of the camera, as well as the current, synchronised timepoint 108 of the recording and, to simplify identification of the reactors being filmed, their identifiers 109 and 110.

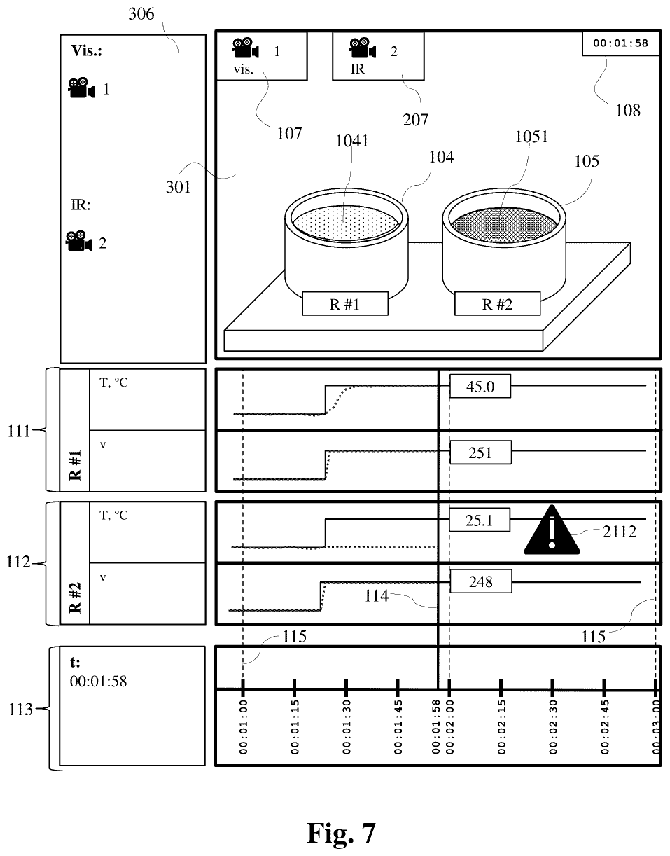

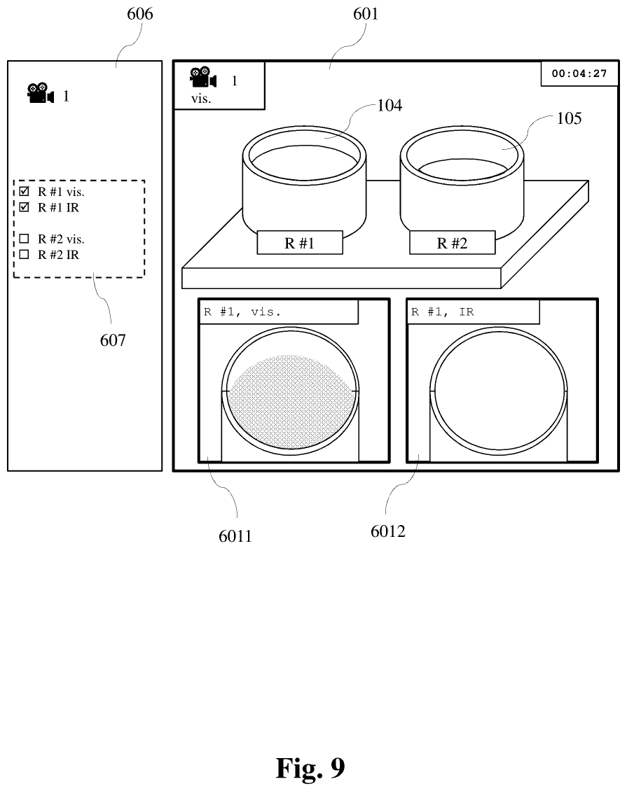

The recording of the video image 101 is typically effected by means of a video camera installed in fixed position or integrated in the device for executing the workflow. It is also possible, however, to use a mobile camera for recording the video image 101, the mobile camera being supported and aligned, for example, by a suitable robot device or by a laboratory worker or even being integrated into a portable device designed especially for augmented reality applications (for example Microsoft's HoloLens). It is, of course, possible and advantageous to use not only one recording source or camera but a plurality thereof (see also FIGS. 7, 8 and 9), it being possible to direct cameras at different objects, and/or use can be made of identical or different objects by means of different types of camera (see also FIG. 9), for example in respect of recording method or wavelength, for example infrared, ultraviolet, image-intensifying, and also sensors for radioactive radiation, etc.

The screen layout shown in FIG. 5 shows, in addition, a plurality of values of selected parameters, here displayed in the form of grouped tracks 111 and 112, which relate to the two reactors 104 and 105. These tracks are advantageously designed so that they show, for example, the desired target value of a parameter (here the reaction temperature T and the rotational speeds v of the stirring devices of the reactors) as well as the actually measured values of the parameters as lines along a time axis 113 which is likewise displayed in the form of a track. In FIG. 5, the target values are shown as solid lines and the actual values as dotted lines. Advantageously, in addition, currently measured values are shown overlaid (here the temperature T 45.0° C. and stirring speed v 251 rpm (revolutions per minute) in reactor #1 and the temperature T 45.1° C. and stirring speed v 248 rpm in reactor #2.

The screen layout shows, as element of central importance, a time axis 113 which runs parallel to the other tracks 111 and 112. The time axis shows the exact timepoint at which the ongoing recording or the playback thereof is taking place. Here the current timepoint is shown, for example, as a continuous line 114 which runs across the various tracks. Dashed lines 115, for example, as auxiliary elements can show certain timepoints (here, for example, each whole minute) and accordingly simplify the read-out of the parameter values in the data tracks 111 and 112.

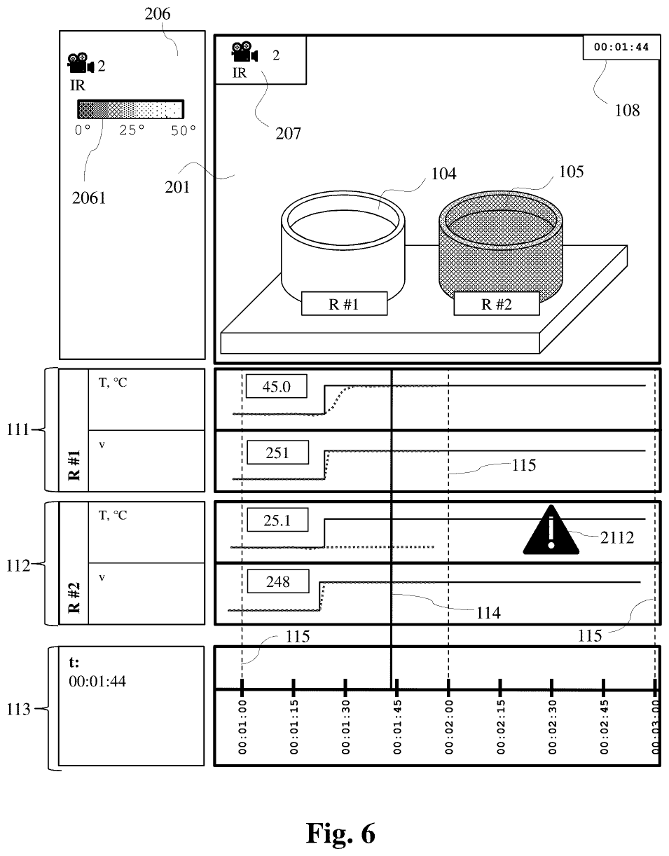

The screen layout shown in FIG. 6 shows a situation similar to that in FIG. 5 except that here the video image 201 of an infrared (IR) camera 207 is shown which displays colder objects in darker colours and warmer objects in lighter colours. An information column 206 shows information relating to the camera used for recording the video image 201. The information column 206 also contains a scale 2061 which indicates in simplified form which colour has been allocated to which detected temperature. The exemplary image layout shows how the first reactor 104 and its contents are hot and are shown in a light colour, while the contents of the second reactor 105 are cooler and therefore shown in a dark colour (indicated by the dotted image). The temperature track of the second reactor shows how that reactor has a lower temperature (dashed temperature line) than would be intended (continuous temperature line). In addition, here a superimposed warning message 2112 indicates that the temperature in the reactor differs substantially from the target value, indicating that the second reactor is apparently not being heated as planned and there may be a technical problem. The warning message 2112 can, of course, also contain suitable text.

The exemplary screen layout shown in FIG. 7 shows a situation similar to that in FIGS. 5 and 6 except that here in the video image 301 shown the recordings originating from two video cameras are displayed partly overlaid. One recording originates from a video camera 107 operating in the visible spectral range, as in FIG. 5, while the other recording originates from an infrared camera 207, as in FIG. 6. Accordingly, in the video image 301 both the video image, which is visible to the human eye, and the IR video image, which records the thermal radiation of objects, are visible simultaneously. By means of known image-processing programs, the entire IR image is not displayed overlaid, but only excerpts thereof that are of interest. In FIG. 7 those excerpts show the thermal radiation of the fluids 1041 and 1051 located in the two reactors 104 and 105. An information column 306 shows information relating to the cameras used for recording the video image 301.

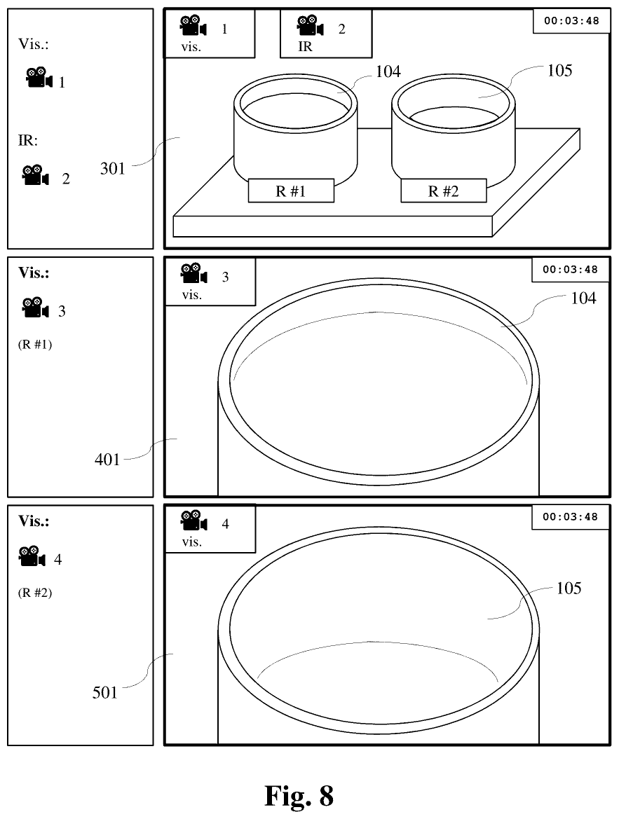

Within the scope of the invention it is also possible for images of a plurality of video cameras, optionally different video cameras, to be displayed, for example, one next to the other or one below the other, so that a plurality of recordings are visible simultaneously, it being possible for cameras operating in different spectral ranges to be directed at the same object or at different objects. The latter case is shown in FIGS. 8 and 9, where data tracks and time tracks have been omitted for the sake of simplicity.

In FIG. 8, the screen layout shows, analogously to FIG. 7, the overlaid video image 301 of a first and a second video camera as well as video images 401 and 501 of two further video cameras which are each directed at one of the two reactors 104 and 105, and accordingly show in detail what is happening in the corresponding reactors. Here in FIG. 8 it is immediately apparent, for example, that the second reactor 105 has a lower fluid level than the first reactor 104.

Advantageously, it is, of course, also possible to switch between different forms of display or camera inputs, that is to say the user can select whether, for example, he wishes to have displayed the video image of a first video camera (as in FIG. 5), the IR image of a second IR camera (as in FIG. 6), an overlay of excerpts of the IR camera over the first video camera (as in FIG. 7) or an overlay of the entire IR image of the IR camera semi-transparently over the video image of the first video camera (not shown). It will be understood that picture-in-picture displays are also possible.

The screen layout shown in FIG. 9 shows a main video image 601 with two smaller sub-video images 6011 and 6012 inside the main video image. The main video image shows the two reactors 104 and 105 as in FIG. 5, the sub-video image 6011 shows a video recording only of the first reactor 104 in the visible spectral range, and the sub-video image 6012 shows a video recording only of the first reactor 104 in the infrared spectral range. An information column 606 has an integrated control field 607 by means of which the display of desired sub-video images can be selected or deselected. In the example here, sub-video images of the second reactor 105 have been deselected.

It will be understood that not only visual and IR cameras come into consideration as input sources, but options include all recording methods, cameras and sensors that are commonly used and conceivable in the future, such as, for example and especially X-rays, for example for identifying what is happening in a reactor without having visual access thereto. Further input options include, for example, UV radiation, image-intensifying cameras, ultrasound sensors, etc. The following sections illustrate, in particular, different ways in which further data tracks which do not come from camera inputs can be displayed according to the invention.

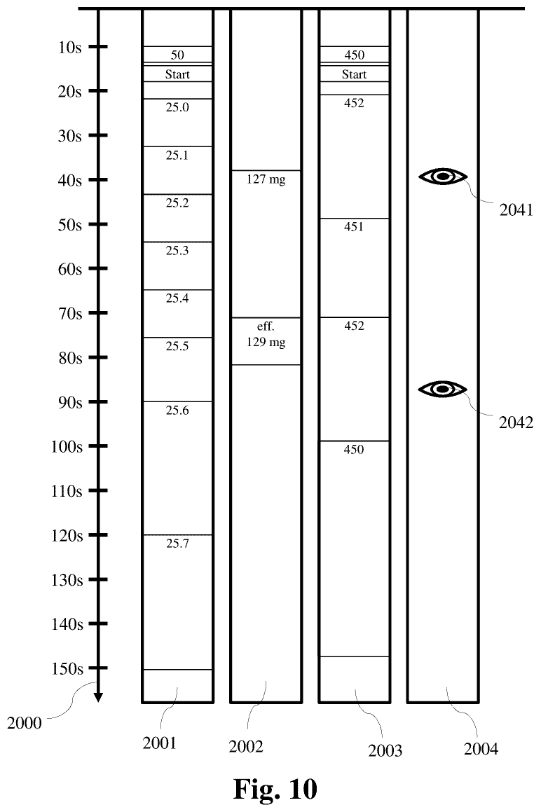

FIG. 10, for example, shows some tracks of data sets of a simplified chemical workflow. In this example the workflow includes the metering of a powder into a stirred and heated vessel.

In the example here, the tracks run vertically on the screen, parallel to a time axis 2000, and are arranged one next to the other. A track 2001 shows recorded temperature profiles in a cryostat. A second track 2002 shows the activity of a powder-metering device and a weighing scales. A third track 2003 shows recorded rotational speeds of a stirrer. A fourth track 2004 shows observations recorded by a user. Each track represents a parameter. Individual data points, for example measurements, as well as actions or observations are displayed at the corresponding timepoint along the time axis 2000.

In the example shown, it can be seen how, for example, shortly after the start (timepoint T0) of the workflow, first a target value of 50° C. is set for the cryostat and a target value of 450 rpm is set for the stirrer (timepoint T0+10 s) and both devices are then started (timepoint T0+15 s). The two devices then begin to operate and the parameters measured (temperature for the cryostat and speed of the stirrer) are recorded.

Timepoint T0+38 s marks the start of a metering operation with a powder-metering device which is intended to meter 127 mg of a specific powder into a specific target vessel. That metering operation is concluded at timepoint T0+72 s, and, for example as a result of the input of a weighing scales, the fact that, in reality, 129 mg of the powder were added is stored.

The laboratory worker observing the automated operation observes foaming in the vessel at T0+40 s and T0+85 s and logs that circumstance in the system. Those observations are displayed in track 2004. In FIG. 10, the observations are represented by symbols 2041 and 2042. In practice, the displayed observation is usually a corresponding text. Manual input of the observation is effected, for example, by means of the input device 17 shown in FIG. 1. Advantageously, however, such manual inputs are effected by means of a data-processing device connected to the computer 16, it being possible in particular to use, for example, smartphones, desktop, laptop or tablet computers, but especially advantageously devices for augmented reality or virtual reality (for example Microsoft's HoloLens products). Conversely, those devices can then also be used correspondingly to display and process data and information recorded during an experiment.

Later, in the analysis phase of the workflow, the laboratory worker can then see exactly what has happened at which timepoint and in what state the individual elements were at the time. He would immediately see, for example, that at timepoint T0+120 s the cryostat is at a temperature of 25.7° C. and the stirrer is rotating at 450 rpm.

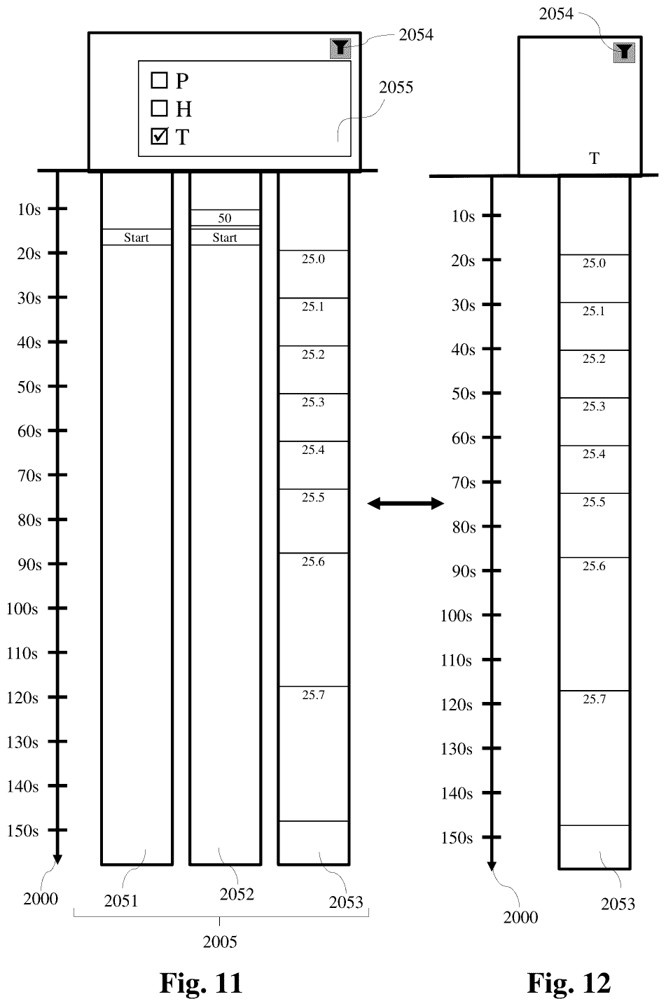

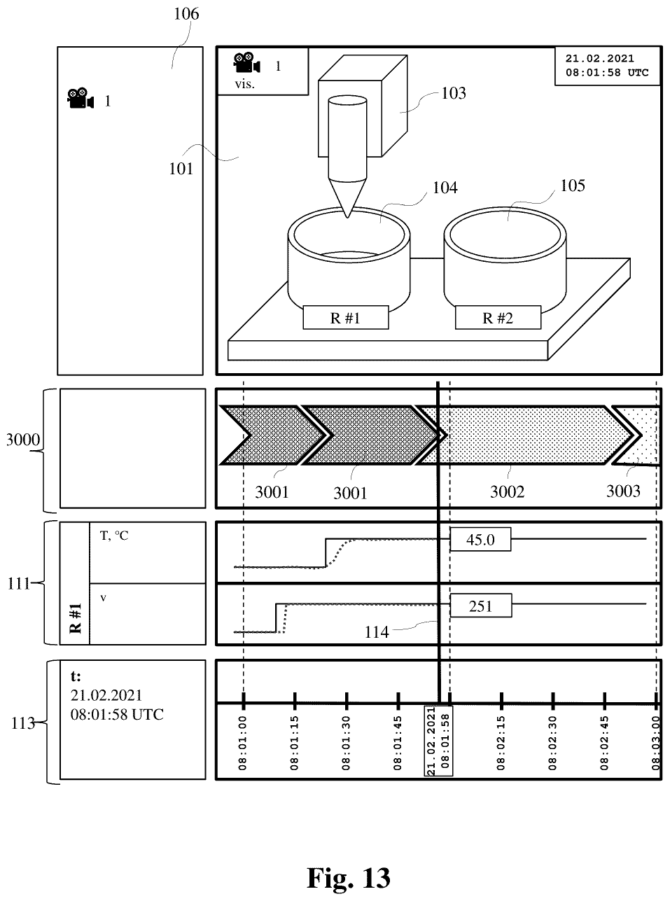

Some of the apparatus and devices involved in the workflow are characterised by several features. For example, a cryostat has a pump, a heater and a temperature sensor. The values or states of those components can all be recorded as parameters. In such a case it is expedient to group the display of the relevant tracks belonging to an element, for example as shown in FIG. 11 using the example of a cryostat. In a track group 2005 having the individual tracks 2051, 2052 and 2053 it is possible to implement a selection field 2055, which is preferably openable by means of a corresponding button 2054, by means of which the individual tracks to be displayed can be selected (pump P, heater H, temperature T). In FIG. 11, the track of the temperature sensor of the cryostat has been selected. That individual track 2053 is then displayed on the screen, as shown in FIG. 12. This simplifies the overview over the displayed data.

The information in the tracks can be displayed not only in the form of text and numbers but, where appropriate, also in the form of graphs (curves), preferably together with corresponding scales, it also being possible to display corresponding target values or desired values. Preferably, legends displayed therewith assist in the identification of the curves that differ, for example, in colour or in line thickness/line shape. FIGS. 5-7 show examples of such graph displays.

It is often the case that scientific experimental workflows are displayed as workflows having defined symbols, where an inscribed arrow symbol in each case comprises a working step (or a group of combined working sub-steps). In the method according to the invention, such a workflow can also be superimposed on the screen display of the parameters and video recordings. FIG. 13 shows an example thereof in simplified form.

The screen layout of FIG. 13 corresponds to a large extent to that of FIG. 5 only that, in addition to the video image 101, the grouped track 111 assigned to the reactor 104 and the time axis 113, there is also shown a workflow track 3000. The grouped track 112 of FIG. 5 is not shown herein. On the time axis 113, the time has been entered as universal time UTC. The vertical line 114 marks the current time.

The workflow shown in the workflow track 3000 corresponds to the planned workflow and indicates what should be done at which timepoint. The individual working steps are displayed as arrows, the status of a working step advantageously being symbolisable by different colours. Already completed workflow steps 3001 can be shown, for example, in dark grey, the currently ongoing workflow step 3002 in mid-grey and the future workflow steps 3003 in light grey. Together with the video image(s), such a display showing a large amount of information, data, images etc. simultaneously provides for the first time a comprehensive log that includes all conceivable aspects of a scientific experimental workflow. Combined with the ability to search data within the totality of the recordings, such a log provides for the first time a complete, comprehensive and unprecedented ability to analyse and re-use logged workflows.

The previously mentioned search within the data sets will be discussed in greater detail hereinbelow.

The various data sets are collated in a common data bank which is installed on the computer 16. Central to this is that all recordings and data sets (tracks, camera images, user inputs, etc.) are time-synchronised, because only in that way is mutual referencing and searching for events, values, parameters, etc. possible. An important aspect of the invention is that all those different recorded and logged data can later be combined, filtered, but especially also searched, in accordance with the most varied requirements. The search can include keywords (for example within commentaries and observations added, for example, by the laboratory worker), but also any parameters and values stored in the total data set. In addition, it is advantageous that the visual tracks (or camera recordings) and sensor inputs are also analysed, interpreted and converted by suitable devices and methods familiar to the person skilled in the art, so that those inputs too can be encompassed by a search mask. For example, the colour of a formulation in a reactor could be recognised by means of image-recognition software and the search would then display all events, times, video sequences and images in which that colour of formulation was recognised. This, of course, also applies to any conceivable physical and chemical parameters, data and values, as well as to those observable by the human being.

For searching the data sets, a search mask can be used in which it is possible, for example, to search for specific values, variables and parameters, as well as for text and speech recordings. All found entries can be listed in tabular form. Advantageously the results can be filtered further and, advantageously, by selection of a found entry it is possible to jump directly to the timepoint of the entry in the time axis and/or to mark or highlight that entry in the time axis and/or track.

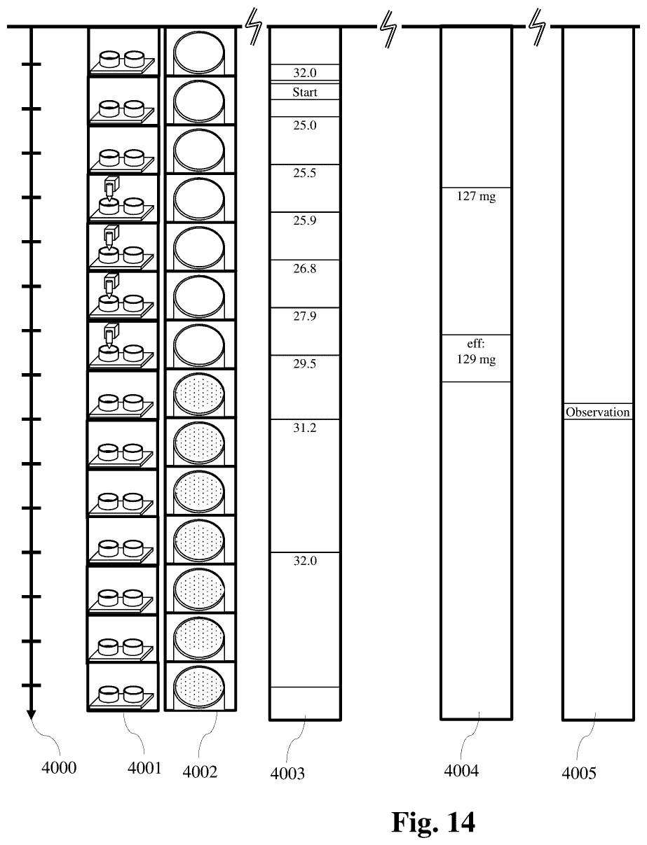

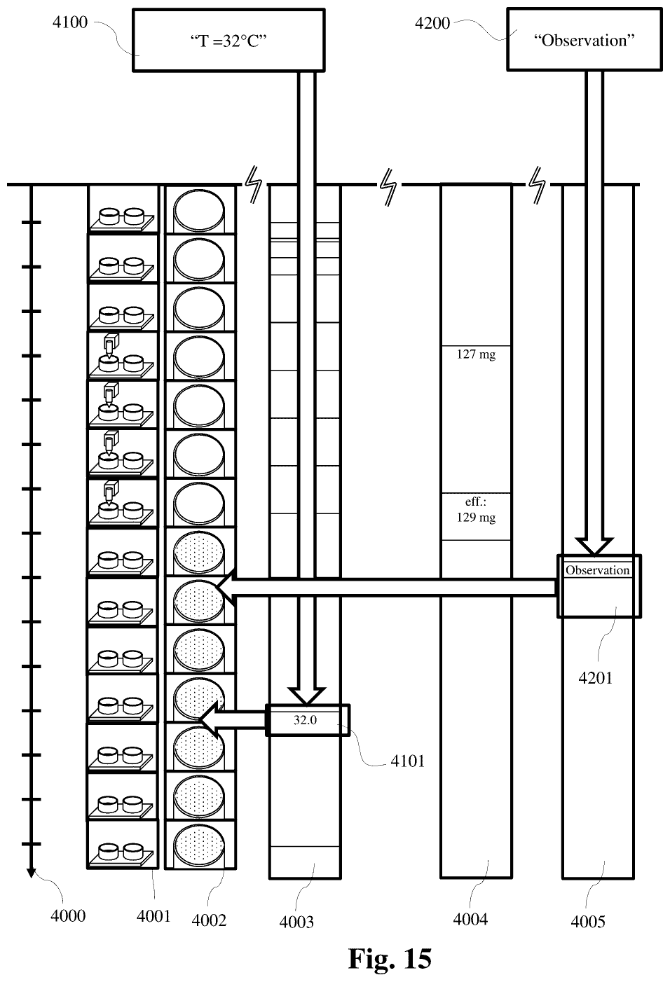

FIGS. 14 and 15 show, for example, how the recorded data and tracks can be searched in accordance with the method according to the invention. FIG. 14 shows a display that is advantageous for search purposes, the display showing various tracks in synchronisation with a common time axis 4000, which in this case—representative of many other possible tracks—are two video tracks 4001 and 4002 of two different video cameras, a track 4003 of a temperature sensor, a track 4004 of a powder-metering device and an acoustic track 4005 with speech inputs by a laboratory worker. The video tracks 4001 and 4002 are displayed in such a way that individual images are shown along the time axis 4000, each image corresponding to the recording at the associated timepoint.

FIG. 15 then shows how the search across the totality of the data tracks of a workflow operates in accordance with the invention: a first exemplary query 4100 within the temperature sensor track 4003 or the underlying data set, for example using the search term “32° C.”, finds a first event 4101 at which that value was measured by a sensor, and directly displays the associated images (or recording sequences) as desired, in the example here at timepoint 14:25:45. Further, subsequent events of the same sensor track that also match the search term 32° C. would then likewise be displayed, as well as, as desired, also events at which that temperature was measured at other sensors. The totality of all found events can then, of course, be filtered with reference to desired criteria. Where two or more events (for example 32° C.) are found, the user can select which associated timepoint or which associated video sequence he wishes to have displayed, because he knows, for example due to his experience, that an event is actually the one being sought or perhaps is only an outlier or measurement error or is otherwise a measured value irrelevant to his query. On the basis of his experience and with reference to the associated video sequence and any additionally displayed parameter values, the user can easily decide which of those search results actually represents the event in which he is interested in the course of the workflow and which he wishes to examine more closely.

An exemplary second query 4200 searches the data set underlying the acoustic track 4005, for example, for an acoustically recorded observation, for example the term “foam”. What is important here is not only that the acoustic recording is available in the form of a customary sound track, but also that the sound track is parameterised or digitalised, for example, by suitable speech-recognition methods and, as a result, for each verbal input by the user a text is also generated and stored at the corresponding timepoint and can then be searched for by means of the search term. Here, therefore, the search query 4200 for “foam” also finds an event 4201 on the acoustic track 4005, where the speech recognition has recognised the term “foam” in the underlying data set, and then shows in turn the desired other tracks, parameters, images and video sequences belonging to that timepoint. As regards any multiple search results, the comments made in the previous paragraph again apply.

A parameterisation or digitalisation of raw data described above for an acoustic track can, of course, take place for any desired track. An evaluation of recordings made by any conceivable method (video, IR, UV, acoustic, . . . ) and the interpretation, parameterisation or digitalisation thereof is especially advantageous. This is comparable with, for example, face-recognition by correspondingly suitable software, where camera recordings of faces are provided with easily recognisable features and those features can then be deposited in comprehensive data banks and compared with one another in order that a recorded image can be compared with and assigned to images already available in the data bank. Similar digitalisation can also be used in the method according to the invention. Here (by way of example and not exhaustively), for example, the colour of a chemical formulation, the structure thereof, the presence of inhomogeneities (particles, foam, . . . ) can then be recognised and digitalised.

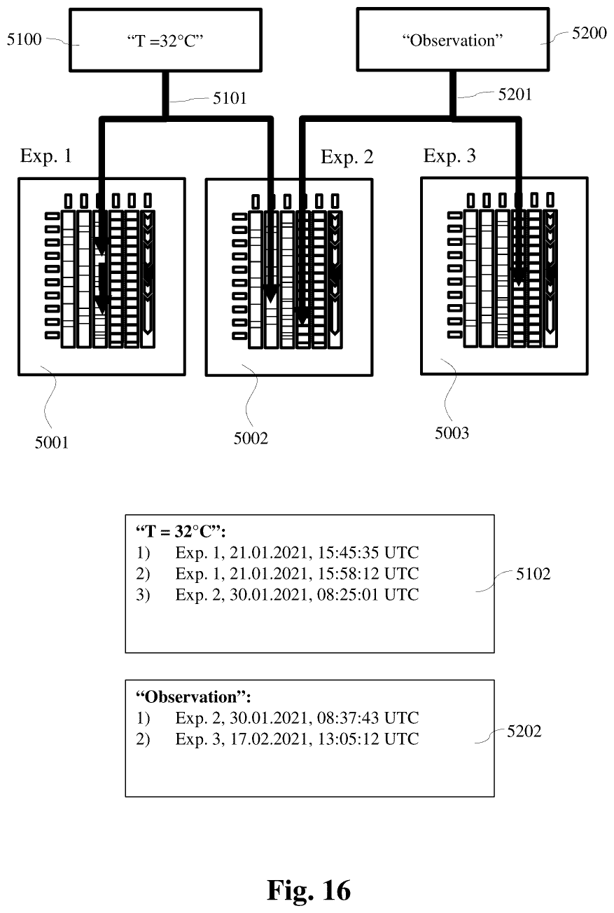

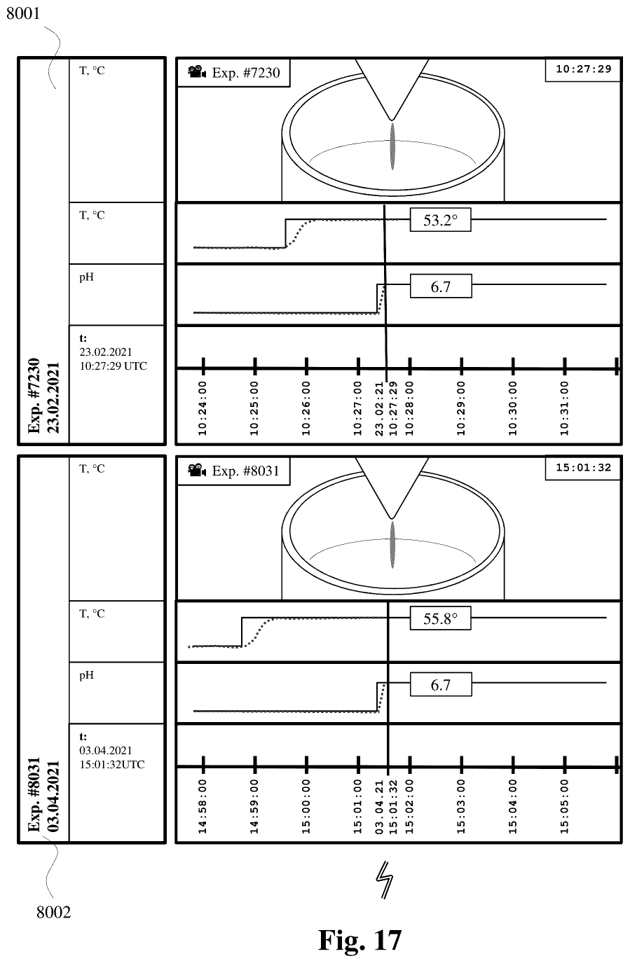

A search for data can, of course, be made not only within a single workflow, but advantageously also across a multiplicity of (comparable) workflows, as shown in in very simplified form in FIG. 16. Here, across the data sets of three workflows 5001, 5002 and 5003, in a query 5100 a search is made, for example, for the events “temperature=32° C.” and in a query 5200 a search is made, for example, for a specific observation, for example the event “foam”. Various events are found, this being symbolised by arrows 5101 and 5201 in FIG. 16. The events found are shown in tabular form in two tables 5102 and 5202. It will be seen that three events of “temperature=32° C.” have been found in two experiments and two events of “foam” have been found in two experiments. By selecting an event in the list, the laboratory worker can then jump directly to the desired timepoint in the desired experiment and view the conditions, parameters etc. prevailing at the time. This makes it possible for the first time to carry out a simple, comprehensive and quick search of parameters in general laboratory operation.

FIG. 17 shows an example of a display of a plurality of recordings 8001 and 8002 of scientific experimental workflows which have been carried out and logged at different times. Here the user has decided to select the addition of a fluid to the test reactors as the timepoint currently to be displayed, for example by searching across the desired experiments for «pH value≥6.7», and has accordingly found those events. Those events can then be displayed, for example, in such a way that the corresponding time axes or recordings are shifted and calibrated to that common event «pH≥6.7». Such a display offers a very intuitively usable way of finding and visually comparing events that are of interest and relevant in workflows, because all desired parameters and recordings are, of course, thus available to the user.

The invention has been explained above using the example of chemical workflows. The invention is not limited to the logging and analysis of chemical workflows, however, but is also suitable for many other scientific experimental workflows.

claims

1

-

15

. canceled

16. A method for logging a scientific experimental workflow, wherein over the course of the workflow a video recording, which comprises a multiplicity of successive individual images, of at least parts of a workspace in which the workflow is being executed and, at the same time, all values of a large number of relevant parameters involved in the workflow are recorded, wherein one of the parameters is a temperature measured by a temperature sensor, and for the video recording and for each individual parameter a separate data sets is stored in a digital data bank, wherein the data sets contain the individual images of the video recording and the values of the parameters over time assigned to a common reference time, so that at each timepoint there is a clear temporal association between the individual images of the video recording and the values of the parameters, and wherein at least the data sets of the parameters are stored in a searchable form, so that it is possible to search for parameter events at which a parameter exhibits a searched value or a searched change.

17. A method for logging and analysing a scientific experimental workflow, wherein over the course of the workflow a video recording, which comprises a multiplicity of successive individual images, of at least parts of a workspace in which the workflow is being executed and, at the same time, all values of relevant parameters involved in the workflow are recorded, wherein one of the parameters is a temperature measured by a temperature sensor, and for the video recording and for each individual parameter a separate data sets is stored in a digital data bank, wherein the data sets contain the individual images of the video recording and the values of the parameters over time assigned to a common reference time, so that at each timepoint there is a clear temporal association between the individual images of the video recording and the values of the parameters, wherein at least the data sets of the parameters are stored in a searchable form and it is searched for parameter events at which a parameter exhibits a searched value or a searched change, and wherein the values of at least selected parameters present at the timepoint of a searched parameter event or present in a time period that includes the timepoint of the searched parameter event and the images of the video recording are visually displayed in temporal association with one another.

18. The method according to claim 16, wherein, for selected parameters, target values of those parameters are stored as data sets in the data bank and visually displayed together with the recorded actual values of those parameters, the variations over time preferably in the form of graphs.

19. The method according to claim 16, wherein the variations in the values of at least selected parameters over time, if applicable together with their corresponding target values, are visually displayed, especially in the form of rows of numbers, in tracks arranged one next to the other or one below the other.

20. The method according to claim 16, wherein as common reference time there is used a standard time, especially universal time UTC or international atomic time TAI.

21. The method according to claim 16, wherein two or more video recordings of the workspace are made from different viewing angles and/or in different wavelength ranges and stored as separate data sets.

22. The method according to claim 16, wherein two or more video recordings of the workspace are made in different wavelength ranges and stored as separate data sets and wherein an at least partly overlaid display of the recorded workspace is generated from those data sets and visually displayed.

23. The method according to claim 16, wherein the values of at least selected parameters, together with the respective timepoint, are input into the data bank automatically or manually by a user.

24. The method according to claim 16, wherein observations recorded in text form or, preferably parameterised, acoustic recordings by a user are stored as separate data sets and/or wherein data sets are provided with commentaries.

25. The method according to claim 16, wherein at least one video recording is made and recorded in the visible spectral range.

26. The method according to claim 16, wherein a video recording is made and recorded in the UV and/or IR spectral range.

27. The method according to claim 16, wherein a parameter contains radiation values such as radioactivity or X-ray radiation, magnetic field values, airflow values or ultrasound measured values.

28. The method according to claim 16, wherein the video recording or video recordings is or are searched for specific image contents or changes therein using an image-recognition method and preferably the values of at least selected parameters temporally associated with the occurrence of the searched image contents or changes therein or with a selectable time period around the occurrence of the searched image contents or changes therein and the images of the video recording are visually displayed in temporal association with one another.

29. The method according to claim 16, wherein planning data of the scientific experimental workflow are stored as a dedicated data set or dedicated data sets.

30. The method according to claim 16, wherein for two or more comparable scientific experimental workflows, over the course of each workflow at least one video recording of at least parts of a workspace in which the respective workflow is being executed and, at the same time, values of parameters relevant to the respective workflow are recorded and stored in searchable form as separate data sets in a digital data bank and preferably visually displayed together in temporal association with one another.

31. The method according to claim 17, wherein, for selected parameters, target values of those parameters are stored as data sets in the data bank and visually displayed together with the recorded actual values of those parameters, the variations over time preferably in the form of graphs.

32. The method according to claim 17, wherein the variations in the values of at least selected parameters over time, if applicable together with their corresponding target values, are visually displayed, especially in the form of rows of numbers, in tracks arranged one next to the other or one below the other.

33. The method according to claim 17, wherein as common reference time there is used a standard time, especially universal time UTC or international atomic time TAI.

34. The method according to claim 17, wherein two or more video recordings of the workspace are made from different viewing angles and/or in different wavelength ranges and stored as separate data sets.

35. The method according to claim 17, wherein two or more video recordings of the workspace are made in different wavelength ranges and stored as separate data sets and wherein an at least partly overlaid display of the recorded workspace is generated from those data sets and visually displayed.
